(19) United States
(12) Patent Application Publication
(10) Pub. No.: US 2024/0244700 A1
(43) Pub. Date: Jul. 18, 2024

(54) Early Data Communication on Bandwidth Parts

(71) Applicant: GOOGLE LLC, Mountain View, CA (US)

(72) Inventor: Chih-Hsiang Wu, Taoyuan City (TW)

(21) Appl. No.: 18/559,318

(22) PCT Filed: May 6, 2022
(86) PCT No.: PCT/US22/28169

§ 371 Date: Nov. 6, 2023

Related U.S. Application Data
(60) Provisional application No. 63/201,639, filed on May 6, 2021.

(51) Int. Cl. H04W 76/20; H04W 72/0457; H04W 74/0833; H04W 76/30

(52) U.S. Cl. CPC H04W 76/20; H04W 72/0457; H04W 74/0833; H04W 76/30

(57) ABSTRACT

To manage small data transmission (SDT) in a UE, a central unit (CU) of a distributed base station that also includes a distributed unit (DU) communicates, via a DU, with a UE operating in a connected state of a protocol for controlling radio resources and configured to communicate with the DU via a first BWP; configures, via the DU, the UE to communicate with the DU on a second BWP in a non-connected state of the protocol; and performs, via the DU, SDT with the UE operating in the non-connected state of the protocol.

### FIELD OF THE DISCLOSURE

This disclosure relates generally to wireless communications and, more particularly, to communication of uplink and/or downlink data on a bandwidth part (BWP) at a user equipment (UE) and a distributed unit (DU) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE in the RRC_IDLE or RRC_INACTIVE state can perform an early data transmission without transitioning to the RRC_CONNECTED state, e.g., by using techniques as specified in section 7.3a-7.3d in 3GPP specification 36.300 v16.4.0. In section 7.3d of the 3GPP specification, a base station (i.e., eNB or ng-eNB) can transmit to the UE an RRCConnectionRelease message including a preconfigured uplink resource (PUR) configuration, while the UE is in the RRC_CONNECTED state. Thus, the UE in one implementation can transmit to the base station an RRCEarlyDataRequest message containing a user data packet, as described in section 7.3d in the 3GPP specification. In another implementation, the UE can transmit to the base station a user data packet on DTCH multiplexed with an RRCConnectionResumeRequest message on CCCH. That is, the UE generates a MAC PDU including an RRCConnectionResumeRequest message and the user data packet, as described in section 7.3d in the 3GPP specification.

It has been proposed to allow early data communication for a 5G NR UE operating in an inactive state (e.g., RRC_INACTIVE) or an idle state (e.g., RRC_IDLE). This procedure can be referred to as small data transmission (SDT) or, sometimes, early data transmission (EDT). However, the UE in some cases may connect to a 5G NR radio access network (i.e., the NG-RAN) that includes distributed base stations, each of which includes a central unit (CU) and at least one distributed unit (DU). It is not clear how a distributed base station (e.g., including a CU and a DU) performs early data communication with the UE, operating in the inactive state or the idle state (e.g., RRC_IDLE), on a bandwidth part (BWP) other than an initial BWP.

### SUMMARY

A UE and/or a distributed base station of this disclosure implement these techniques to use one BWP for communicating in the connected state of a protocol for controlling radio resources, e.g., the RRC_CONNECTED state of the RRC protocol, and another BWP for communicating small data in the non-connected state of the protocol, e.g., RRC_INACTIVE or RRC_IDLE. The small data transmission (SDT) can include downlink and/or uplink communications, and the BWP used for SDT can include an uplink (UL) BWP and/or downlink (DL) BWP. This BWP can partially or completely overlap the BWP used for communicating in the connected state. The CU can obtain a configuration of the BWP for SDT from the DU and transmit this configuration to the UE via the DU.

One example embodiment of these techniques is a method for managing SDT a UE, implemented in a CU of a distributed base station that also includes a DU. The method includes communicating, via a DU, with a UE operating in a connected state of a protocol for controlling radio resources and configured to communicate with the DU via a first BWP. The method further includes configuring, via the DU, the UE to communicate with the DU on a second BWP when the UE is in a non-connected state of the protocol; and performing, via the DU, SDT with the UE operating in the non-connected state of the protocol.

Another example embodiment of these techniques is a method for managing SDT in a UE, implemented in a DU of a distributed base station that also includes a CU. The method includes communicating with a UE on a first BWP, when the UE operates in a connected state of a protocol for controlling radio resources; receiving, from the CU, a configuration according to which the UE is to perform SDT in a non-connected state of the protocol, the configuration including an indication of a second BWP; transmitting, on the first BWP, the configuration to the UE; and performing SDT with the UE on the second BWP when the UE operates in the non-connected state of the protocol.

Yet another example embodiment of these techniques is a network node including processing hardware and configured to implement one of the methods above.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2 is a block diagram of an example protocol stack according to which the UE of FIG. 1A communicates with base stations;

FIG. 3A illustrates an example scenario in which a UE communicates with a distributed base station on a first BWP, the CU obtains a second BWP configuration for SDT from the DU, and the DU forwards the second BWP configuration to the UE in a command to release the RRC connection;

FIG. 3B illustrates an example scenario generally similar to that of FIG. 3A, but here the DU forwards the second BWP configuration to the UE in a command to reconfigure the RRC connection;

FIG. 3C illustrates an example scenario in which the UE performs a four-step random access procedure and SDT on a first BWP and, in response to receiving a DU configuration, switches to a second BWP to continue performing the SDT;

FIG. 3D illustrates an example scenario generally similar to that of FIG. 3C, except that here the UE performs a two-step random access procedure and SDT on the first BWP;

FIG. 4A illustrates an example scenario in which the UE performs SDT on a first BWP, switches from the first BWP to a second BWP, and conducts a random access procedure on the second BWP to continue the SDT;

FIG. 4B illustrates an example scenario in which the UE performs SDT on a first BWP and remains on the first BWP to perform a random access procedure on the second BWP to continue the SDT;

FIG. 5 illustrates a scenario in which the UE switches to a second BWP in response to determining that the configured resources associated with the first BWP are invalid;

FIG. 6 is a flow diagram of an example method in a UE for performing SDT on a first of a second UL BWP, depending on whether the RAN included a configuration for the second UL BWP in a message to the UE;

FIG. 7 is a flow diagram of an example method in a UE for determining whether the UE should switch to another BWP for SDT, depending on the configured resources the UE received from the RAN;

FIG. 8A is a flow diagram of an example method in a UE for determining whether the UE should switch to another BWP for SDT, depending on whether the first UL BWP is configured for random access;

FIG. 8B is a flow diagram of a method similar to that of FIG. 8A, but here the UE determines to not switch to the second BWP when the first UL BWP is not configured for random access;

FIG. 8C is a flow diagram of an example method in a UE for determining whether the UE should switch to another BWP for SDT, depending on whether the UE has valid configured resources;

FIG. 9A is a flow diagram of an example method for determining on which BWP the UE should transmit a HARQ acknowledgement, depending on whether the RAN provided a configuration for the second BWP via RRC release or RRC reconfiguration;

FIG. 9B is a flow diagram of an example method for determining on which BWP the UE should transmit a HARQ acknowledgement, depending on whether the RAN provided a configuration for the second BWP with a request to transition to the inactive state;

FIG. 9C is a flow diagram of an example method for determining on which BWP the UE should transmit channel state information, depending on whether the RAN provided a configuration for the second BWP via RRC release or RRC reconfiguration;

FIG. 9D is a flow diagram of an example method for determining on which BWP the UE should transmit channel state information, depending on whether the RAN provided a configuration for the second BWP with a request to transition to the inactive state;

FIG. 10 is a flow diagram of an example method in a UE for determining whether the UE can use a previously received configured grant after BWP switching;

FIG. 11 is a flow diagram of an example method in a DU for configuring SDT at a UE;

FIG. 12 is a flow diagram of an example method for in a DU for communicating with a UE on a first BWP and a second BWP; and

FIG. 13 is a flow diagram of an example method in a CU for configuring a UE with a BWP for SDT.

### DETAILED DESCRIPTION OF THE DRAWINGS

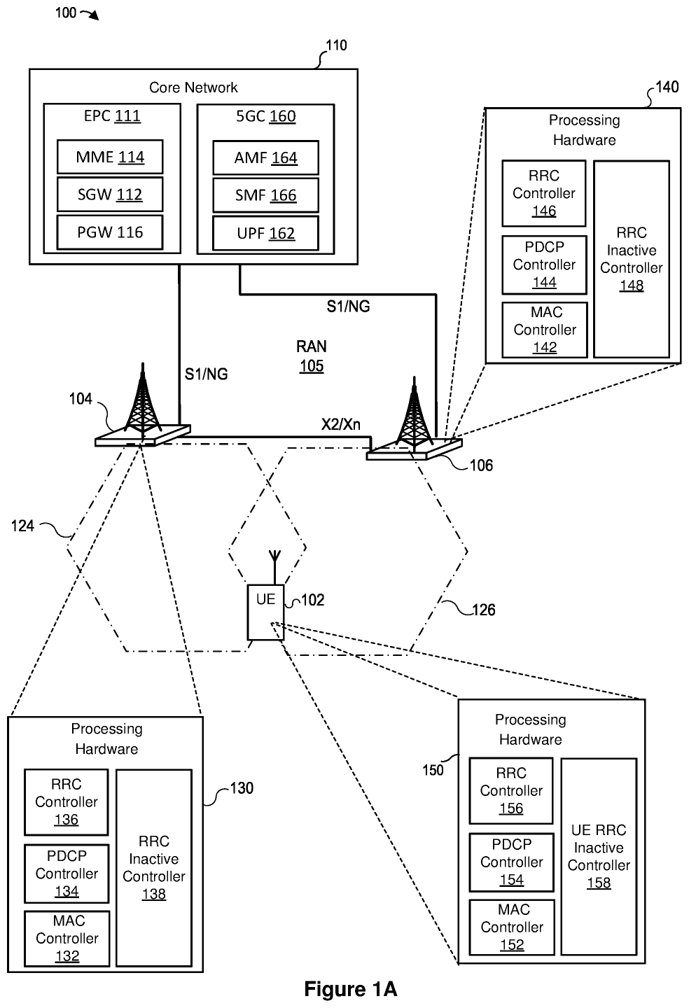

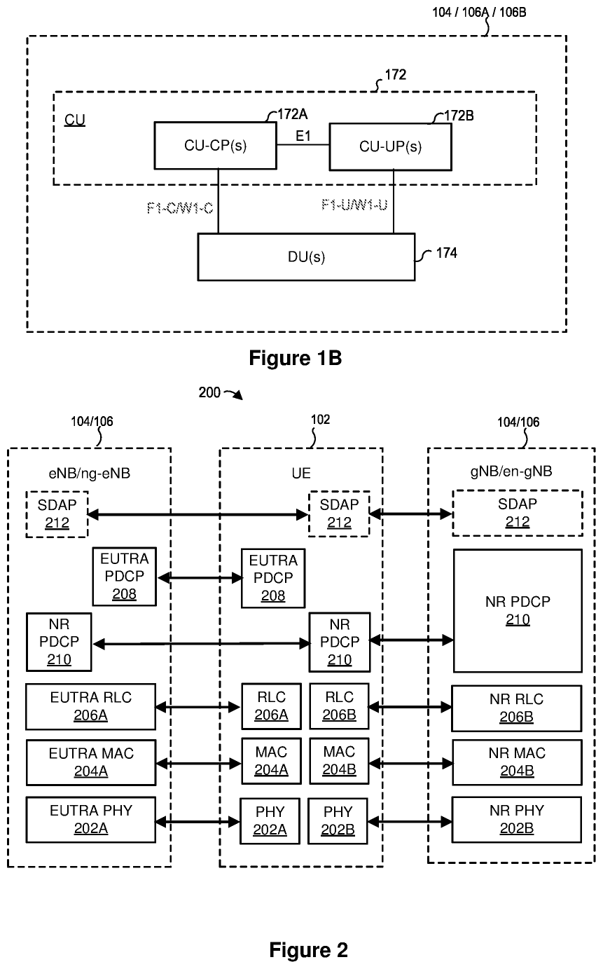

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 160 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1, the base station 104 supports a cell 124, and the base station 106 supports a cell 126. The cells 124 and 126 can partially overlap, so that the UE 102 can select, reselect or hands over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 of this disclosure reduces latency in uplink transmission of data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QoS) flows (e.g., service data adaptation protocol (SDAP)). The data to which the UE and/or the RAN applies the techniques of this disclosure can include for example Internet of things (IoT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, then selects a cell of the base station 104, and exchanges data with the base station 104 either via the base station 106 or with the base station 104 directly, without transitioning to the RRC_CONNECTED state. As a more specific example, after the UE 102 determines that data is available for uplink transmission in the RRC_INACTIVE or RRC_IDLE state, the UE 102 can apply one or more security functions to the UL data packet, generate a first UL protocol data unit (PDU) including the security-protected packet, include an uplink (UL) RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), resume ID or a non-access stratum (NAS) ID. The NAS ID can be a S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may not include a UL RRC message in the UL MAC PDU. In this case, the UE 102 may not include a UE ID of the UE 102 in the UL MAC PDU that does not include a UL RRC message. In yet other implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In other implementations, the UE can obtain the RRC MAC-I from the UL RRC message with an integrity key (e.g., K_{RRCint} key), an integrity protection algorithm, and other parameters such as COUNT (e.g., 32-bit, 64-bit or 128-bit value), BEARER (e.g., 5-bit value), and DIRECTION (e.g., 1-bit value).

In other implementations, the data is an uplink (UL) protocol data unit (SDU) of the NAS. The UE 102 applies the security function to the SDU and includes the secured SDU in a first UL PDU such as a NAS PDU, which can be associated with the NAS layer. For example, the NAS layer can be 5G MM or SM sublayer of 5G, evolved packet system (EPS) or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based to the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an (de-) encryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. On the other hand, when the base station 104 determines the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an (de-) encryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the data CN 112. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieve the data from the security-protected packet and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that security-protected packet includes the data and the MAC-I. When encryption is enabled, the base station 104 encrypts the data to generate an encrypted packet, so that security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generate a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., RRC release message or an RRC reconfiguration message) that the base station transmits to the UE 102 before transmitting the DCI and scrambled CRC.

The UE 102 operating in the RRC_INACTIVE or RRC_IDLE state can receive the DCI and scrambled CRC on the PDCCH. Then the UE 102 confirms that the second DL PDU is addressed to the UE according to the ID of the UE 102. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 then can verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit PDCP PDUs in accordance with which the base station 104 can transmit data in the downlink direction, in some scenarios, and receive PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 142, 144, 146, and 148 can be similar to the components 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 132 configured to perform a random access procedure with a base station, transmit uplink MAC protocol data units (PDUs) to the base station, and receive downlink MAC PDUs from the base station. The processing hardware 150 can also include a PDCP controller 154 configured to transmit PDCP PDUs in accordance with which the UE 102 can transmit data in the uplink direction, in some scenarios, and receive PDCP PDUs in accordance with which the UE 102 can receive data in the downlink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104A, 104B, 106A, or 106B includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include a RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The processing hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. If the CU-CP and DU(s) belong to a gNB, the CU-CP 172A can be connected to one or more DU 174s through an F1-C interface and/or an F1-U interface. If the CU-CP and DU(s) belong to a ng-eNB, the CU-CP 172A can be connected to one or more DU 174s through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets or Ethernet packets.

Thus, it is possible to functionally split the radio protocol stack, as shown by the radio protocol stack 250 in FIG. 2B. The CU at any of the IAB-donors 108A, 108B, or 108C can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU located at the IAB-node 104. To support connection to a 5GC, NR PDCP 210 provides SRBs to RRC 214, and NR PDCP 210 provides DRBs to SDAP 212 and SRBs to RRC 214.

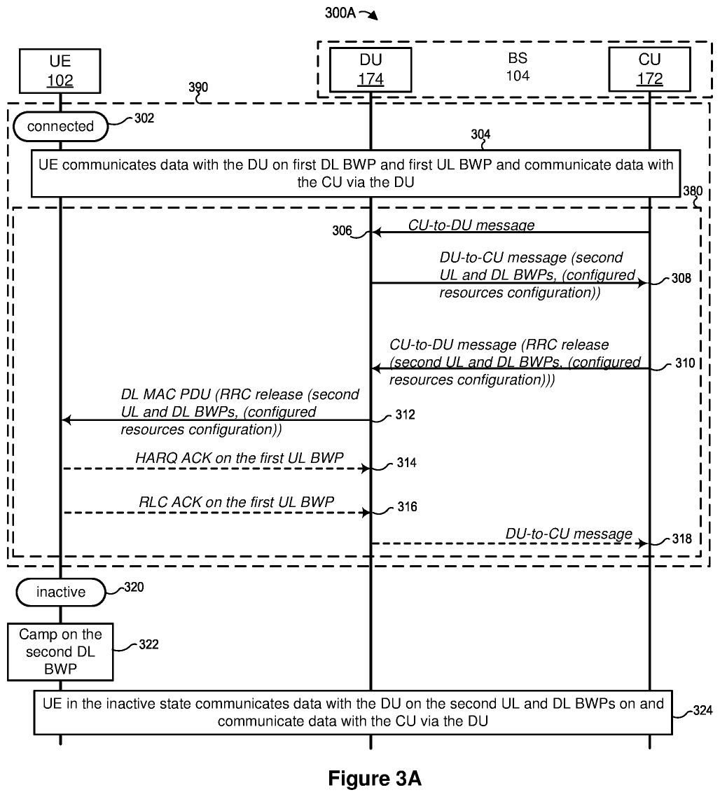

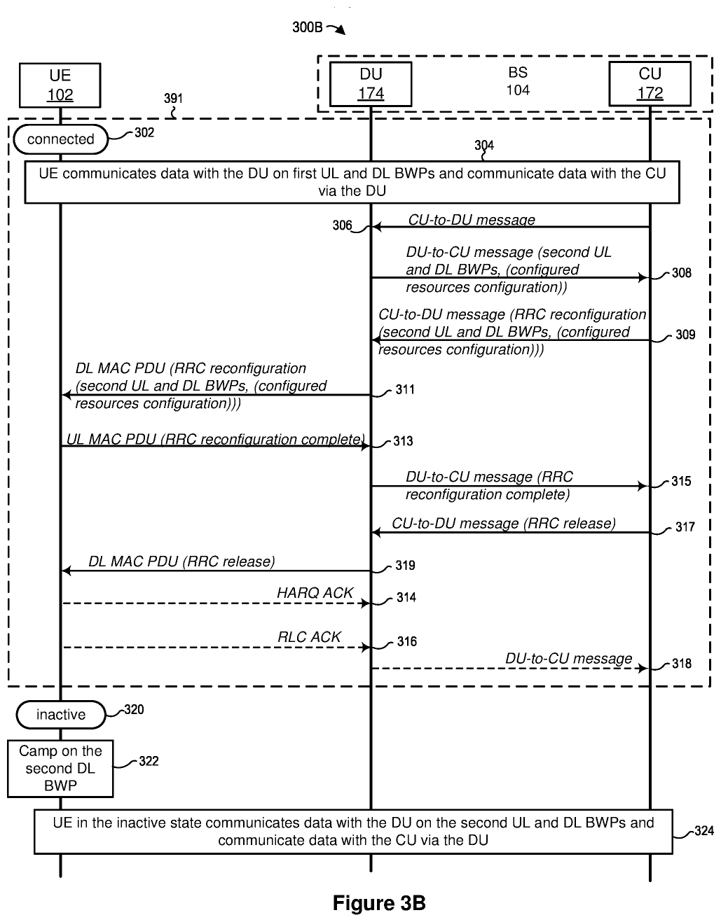

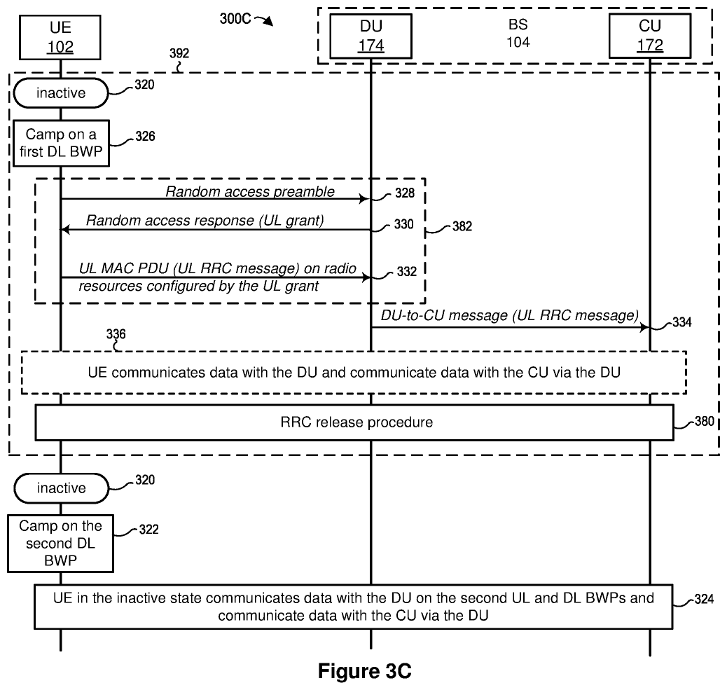

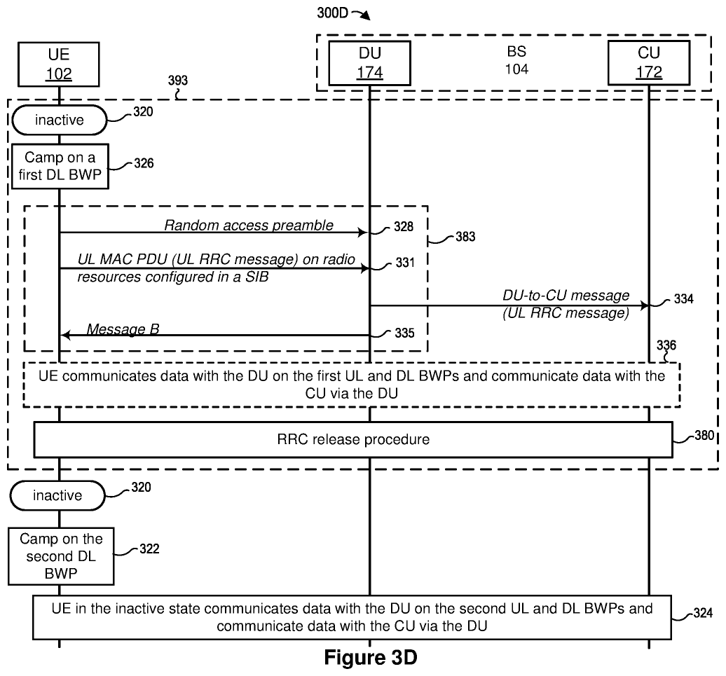

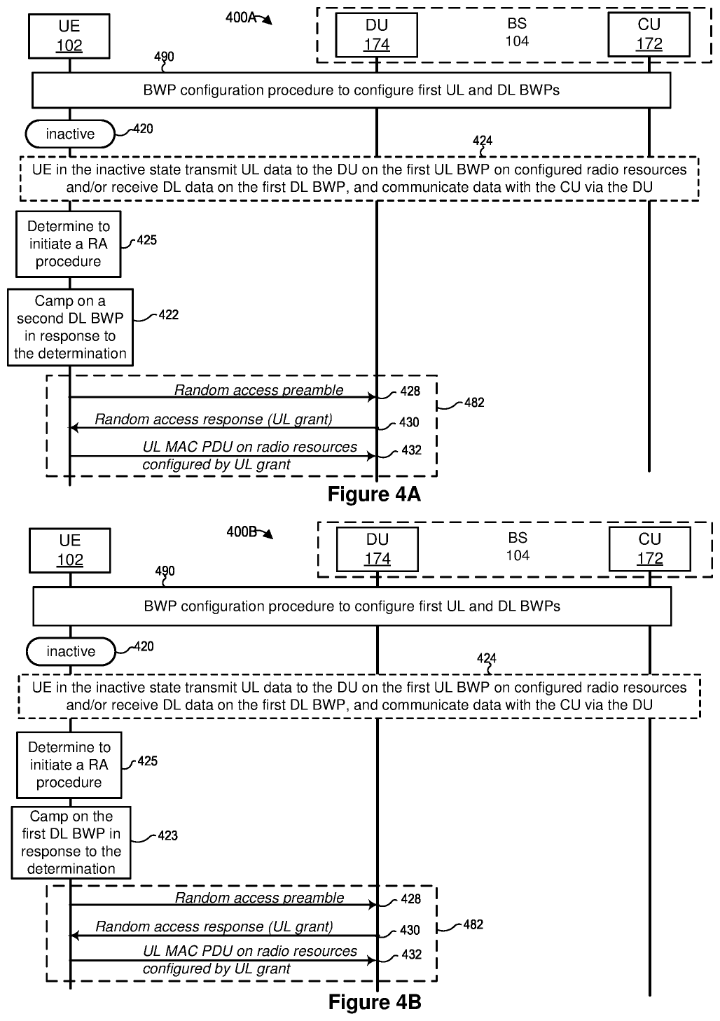

Next, several example scenarios that involve several components of FIG. 1A and relate to transmitting data in an inactive or idle state with configured uplink grant(s) are discussed next with reference to FIGS. 3A-5B. Furthermore, several example scenarios that involve several components of FIG. 1A and relate to transmitting data in an inactive or idle state with configured downlink assignment(s) are discussed next with reference to FIGS. 4A and 4B. To simplify the following description, the “inactive state” is used and can represent the RRC_INACTIVE or RRC_IDLE state.

Referring first to FIG. 3A, in a scenario 300A, the UE 102 initially operates 302 in a connected state (e.g., RRC_CONNECTED) with the base station 104 including a CU 172 and a DU 174. The UE 102 in the connected state communicates 304 data with the DU 174 on a first DL BWP and a first UL BWP of cell 124, and communicates 304 (the) data with the CU via the DU. For example, the data the UE 102 and DU 174 communicate can include hybrid automatic repeat request (HARQ) acknowledgement (ACK), HARQ negative acknowledgement (NACK), channel state information (CSI), downlink (DL) control information (DCI), MAC PDU(s), and/or RLC PDU(s). The data the UE 102 and the CU 172 can communicate via the DU 174 can include PDCP PDUs, SDAP PDUs, RRC PDUs and/or NAS PDUs.

At some point, the CU 172 can determine that neither the CU 172 nor the UE 102 has transmitted any data in the downlink direction or the uplink direction, respectively, during a certain period of inactivity. In some implementations, the DU 174 can send a DU-to-CU message indicating data inactivity of the UE 102 to the CU 172 to assist with this determination. In response to this determination, the CU 172 sends 306 a CU-to-DU message to the DU 174 to obtain a configuration for early data communication for the UE 102. In response to the CU-to-DU message 306, the DU 174 sends 308 a DU-to-CU message to the CU 172. The DU 174 includes, in the DU-to-CU message 308, configuration(s) configuring second UL BWP and second DL BWP for the UE to camp on and/or perform early data communication while operating in the inactive state. In some implementations, the DU 174 can include a cell identity (e.g., of the cell 124 or a cell other than the cell 124) in the configuration(s) to configure the second UL BWP and the second DL BWP operated on the cell. In other implementations, the DU 174 does not include a cell identity in the configuration(s), which implicitly configures the cell identity of the cell 124, i.e., the same as the cell where the UE uses the first UL BWP and the first DL BWP. When the DU 174 does not configure the second UL BWP and the second DL BWP in the DU-to-CU message 308, the DU 174 configures the UE 102 to use an initial UL BWP and an initial DL BWP after the UE 102 transitions to the inactive state and operates in the inactive state. The DU 174 can associate or pair the second UL BWP with the second DL BWP. The second UL BWP and the second DL BWP can be different from the initial UL BWP and the initial DL BWP of the cell.

In some implementations, the DU 174 can determine to configure the second UL BWP and the second DL BWP for the UE 102 in accordance with information in the CU-to-DU message 306. For example, the CU 172 can indicate the DU 174 to configure the second UL BWP and the second DL BWP in the information. In other implementations, the information includes quality of service (QoS) information (e.g., including QoS parameters, QoS flow ID, and/or QoS characteristics) for the UE 102 or one or more radio bearers (e.g., DRB(s)) or QoS flows of the UE 102. The DU 174 determines to configure the second UL BWP and the second DL BWP to meet QoS indicated in the QoS information. For example, the DU 172 determines that a particular data rate or latency for early data communication is required based on the QoS information. In response to the determination, the DU 174 configures the second UL BWP and the second DL BWP to ensure the particular data rate or latency for early data communication.

In some implementations or configurations of the DU 174, the DU 174 configures the second UL BWP and the second DL BWP for early data communication instead of the initial UL BWP and the initial DL BWP. In other implementations or configurations, the DU 174 can (determine to) configure the second UL BWP and the second DL BWP based on radio resources utilization, radio resources availability or traffic on the second UL BWP and/or the second DL BWP, and/or radio resources utilization, radio resources availability, or traffic on other UL BWP(s) and/or other DL BWP(s). The other UL BWP(s) can include the initial UL BWP and/or non-initial UL BWP(s) other than the second UL BWP. The other DL BWP(s) can include the initial DL BWP and/or non-initial DL BWP(s) other than the second DL BWP. For example, the DU 174 can (determine to) configure the second UL BWP and the second DL BWP, because radio resources utilization (or traffic) on the other UL BWP(s) is above a first threshold and/or radio resources utilization on the other DL BWP(s) is above a second threshold, and/or because radio resources utilization (or traffic) on the second UL BWP is below a third threshold and/or radio resources utilization (or traffic) on the second DL BWP is below a fourth threshold. The threshold(s) can be configured, predetermined or dynamically calculated. In some implementations, some or all of the thresholds can be the same or different. In some implementations, the first threshold is larger than the third threshold. In other implementations, the second threshold is larger than the fourth threshold.

In another example, the DU 174 can (determine to) configure the second UL BWP and the second DL BWP, because radio resources availability on the other UL BWP(s) is below a first threshold and/or radio resources utilization on the other DL BWP(s) is below a second threshold, and/or because radio resources availability on the second UL BWP is above a third threshold and/or radio resources availability on the second DL BWP is above a fourth threshold. The threshold(s) can be configured, predetermined or dynamically calculated. In some implementations, some or all of the thresholds can be the same or different. In some implementations, the first threshold is smaller than the third threshold. In other implementations, the second threshold is smaller than the fourth threshold.

In some implementations, the DU 174 can include, in the DU-to-CU message 308, at least one configured resources configuration for the UE 102 to perform uplink (UL) transmission and/or receive downlink (DL) transmission(s). In some implementations, the at least one configured configuration can include a configured grant (CG) configuration for the UE 102 to perform UL transmission and/or a semi-persistent scheduling (SPS) configuration for the UE 102 to receive DL transmission(s). In some implementations, the DU 174 can include a RNTI in the DU-to-CU message and/or the at least one configured resources configuration at event 308. The DU 174 can include configuration(s) of second UL and DL BWPs of the cell 124 or a cell other than the cell 124 in the DU-to-CU message 308.

After receiving 308 the DU-to-CU message, the CU 172 generates an RRC release message (e.g., RRCRelease message or RRCConnectionRelease message), to include the configuration(s) of the second UL and DL BWPs and optionally include at least one configured resources configuration and instruct the UE 102 to transition to the inactive state. Then the CU 172 send 310 a CU-to-DU message including the RRC release message to the DU 174, which in turn transmits 312 a DL MAC PDU including the RRC release message to the UE 102 on the first DL BWP.

In some implementations, the RNTI can be a preconfigured uplink resources RNTI (PUR-RNTI). In other implementations, the RNTI can be a configured scheduling RNTI (CS-RNT) for the inactive state. In some implementations, the CU 172 can assign an I-RNTI or a resume ID to the UE 102 and include the assigned value in the RRC release message.

After receiving 312 the DL MAC PDU, the UE 102 can transmit 314 a HARQ ACK on the first UL BWP to the DU 174 to indicate the successful reception of (a HARQ transmission of) the DL MAC PDU. In some implementations, the UE 102 retrieves a RLC PDU including the RRC release message from the DL MAC PDU and sends 314 a RLC ACK on the first UL BWP to the DU 174 to indicate the successful reception of the RLC PDU. After receiving 314 the HARQ ACK or 316 the RLC ACK, the DU 174 can send 318 a DU-to-CU message on a control plane interface to the CU 172 to indicate successful delivery of the RRC release message. Alternatively, the DU 174 can send 318 a DL Data Delivery Status message on a user plane interface to indicate successful delivery of the RRC release message instead of the DU-to-CU message. In some implementations, if the CU does not receive the DU-to-CU message 318 from the DU within a time period after transmitting 310 the CU-to-DU message or the DL Data Delivery Status message, the CU 172 can send a UE Context Release Command message to the DU 174 to release the at least one configured resources configuration or a UE Context of the UE 102. In response, the DU 174 can send a UE Context Release Complete message to the CU 172. The time period can be preconfigured or predetermined by the CU 172, or configured by an operation and maintenance (O&M) node.

In some implementations, if the DU 174 receives neither the HARQ ACK nor the RLC ACK within a time period after transmitting the RRC release message, the DU 174 can send 318 to the CU 172 to a DU-to-CU message (e.g., UE Context Release Request message) to the CU 172, e.g., to request the CU 172 to release a UE Context of the UE 102. In response to the DU-to-CU message 318, the CU 172 can send a UE Context Release Command message to the DU 174 to release the UE Context. In response to the UE Context Release Command message, the DU 174 releases the UE Context and can send a UE Context Release Complete message the CU 172. In other implementations, if the DU 174 neither receives the HARQ ACK nor the RLC ACK, the DU 174 can release the at least one configured resources configuration and send 318 a DU-to-CU message (e.g., UE Context Release Request message, a UE Context Modification Required message or a new F1 AP or W1 AP message) to the CU 172, e.g., to indicate the configured resources configuration(s) is released. The time period can be preconfigured or predetermined by the DU 174, or configured by the CU 172 or an operation and maintenance (O&M) node.

The UE 102 transitions to the inactive state in response to receiving the RRC release message and operates 320 in the inactive state. In some implementations, the UE 102 transitions to the inactive state after transmitting 314 the HARQ ACK and/or 316 the RLC ACK. If the UE 102 transitions to the inactive state before transmitting 314 the HARQ ACK and/or 316 the RLC ACK, the UE 102 stops perform uplink transmission in response to transitioning to the inactive state. Thus, the UE 102 in the inactive refrains from transmitting 314 the HARQ ACK and 316 the RLC ACK. The UE 102 camps 322 on the second DL BWP in response to or in accordance with the configuration of the second DL BWP. At a later time, the UE 102 in the inactive state initiates early data communication to transmit uplink (UL) data or receive downlink (DL) data. The UE 102 can initiate early data communication in order to transmit at least one UL data packet or to receive at least one DL data packet. In cases where the UE 102 initiates early data transmission (EDT) to transmit UL data while the UE 102 is in the inactive state, the initial early data communication can be mobile originating (MO) EDT. In cases where the UE 102 initiates early data communication to receive DL data while the UE 102 operates in the inactive state, the initial early data communication can be mobile terminating (MT) EDT (i.e., early data reception from the viewpoint of the UE 102). In such cases, the UE 102 at event 314 receives from the DU 174 a paging message, which includes a UE ID of the UE 102 and an EDT indication. For example, the UE ID can be an I-RNTI, resume ID, or a NAS ID (e.g., S-TMSI or 5G-S-TMSI, or a specific ID for MT EDT). In response to the paging message (i.e., the UE ID and the EDT indication), the UE 102 initiates early data communication to receive DL data from the DU 174 and CU 172.

In response to or after initiating early data communication, the UE 102 in the inactive state communicates 324 data with the DU 174 on the second UL BWP and the second DL BWP and communicate 324 (the) data with the CU 172 via the DU 174. In some scenario and implementations, the UE 102 can transmit 324 data to the DU 174 on the second UL BWP. For example, the UE 102 can generate an initial UL MAC PDU including a UL RRC message and transmits 324 (a HARQ transmission of) the initial UL MAC PDU on the second UL BWP to the DU 174. In some implementations, the UE 102 can include initial UL data in the initial UL MAC PDU in addition the UL RRC message to perform a MO EDT. In other implementations, the UE 102 does not include initial UL data in the initial UL MAC PDU, in order to perform MT EDT. After transmitting the initial UL MAC PDU, the UE 102 in the inactive state can transmit 324 subsequent UL MAC PDU(s) including subsequent UL data on the second UL BWP to the DU 174 in the MO EDT or MT EDT. If the RRC release message includes the CG configuration, the UE 102 can transmit 324 the initial UL MAC PDU and/or the subsequent UL MAC PDU(s) on radio resources configured in the CG configuration (i.e., CG radio resources) on the second UL BWP to the DU 174. The DU 174 retrieves the (initial and/or subsequent) UL data from the (initial and/or subsequent) UL MAC PDU(s) and sends the (initial and/or subsequent) UL data to the CU 172.

If the RRC release message does not include the CG configuration, the UE 102 can transmit 324 the initial UL MAC PDU and/or the subsequent UL MAC PDU(s) on dynamic radio resources on the second UL BWP to the DU 174. In this case, the UE 102 can perform a random access procedure (similar to the random access procedure described for FIG. 3C or FIG. 3D) on the second UL BWP and the second DL BWP to perform the MO EDT or MT EDT. In the random access procedure, the UE 102 sends a Message 3 or Message A, including the initial UL MAC PDU, on the second UL BWP and the second DL BWP to the DU 174. After transmitting the initial UL MAC PDU in the random access procedure, the UE 102 can receive from the DU 174 one or more DCI(s) allocating radio resources for the UE 102 to transmit the subsequent UL MAC PDU(s) on the second UL BWP to the DU 174. More specifically, the DU 174 can generate a CRC for each of the DCI(s) and scramble the CRC with a specific RNTI (e.g., a C-RNTI of the UE 102 or the RNTI in the configured resources configuration), and transmit each of the DCI(s) and the scrambled CRC of the DCI on a PDCCH on the second DL BWP to the UE 102. When the UE 102 in the inactive state receives a DCI and a scrambled CRC of the DCI on a PDCCH, the UE 102 determines the DCI addressed to the UE 102 in accordance with the scrambled CRC and the specific RNTI and transmits a HARQ transmission of a particular UL MAC PDU on the second UL BWP to the DU 174 in accordance with the DCI.

If the RRC release message includes the SPS configuration, after transmitting the initial UL MAC PDU, the UE 102 in the inactive state can receive 324 from the DU 174 DL MAC PDU(s) including DL data on configured resources configured in the SPS configuration on the second DL BWP. If the RRC release message does not include a SPS configuration, after transmitting the initial UL MAC PDU, the UE 102 in the inactive state can receive 324 from the DU 174 DL MAC PDU(s) on dynamic radio resources on the second DL BWP. The DU 174 can transmit 324 to the UE 102 one or more DCIs on the second DL BWP to configure the dynamic radio resources for the UE 102 to receive the DL MAC PDU(s). More specifically, the DU 174 can generate a CRC for each of the DCI(s) and scramble the CRC with a specific RNTI (e.g., a C-RNTI of the UE 102 or the RNTI in the configured resources configuration), and transmit each of the DCI(s) and the scrambled CRC of the DCI on a PDCCH to the UE 102. When the UE 102 in the inactive state receives a DCI and a scrambled CRC of the DCI on a PDCCH, the UE 102 determines the DCI addressed to the UE 102 in accordance with the scrambled CRC and the specific RNTI and receives a HARQ transmission of a DL MAC PDU on the second DL BWP in accordance with the DCI.

In some implementations, the initial and/or subsequent UL data include PDCP PDU(s), RLC PDU(s), RRC PDU(s), NAS PDU(s), and/or IP packet(s) associated to SRB(s), DRB(s) and/or QoS flow(s). In other implementations, the initial UL data includes user-plane data and/or control-plane data. The user-plane data includes Internet of things (IoT) data, Ethernet traffic data, Internet traffic data, or a short message service (SMS) message. The control-plane data includes RRC message(s) and/or NAS message(s).

The events 306, 308, 310, 312, 314, 328, 316 and 318 are collectively referred to in FIG. 3A as a RRC release procedure 380. The events 302, 304 and 380 are collectively referred to in FIG. 3A as a BWP configuration procedure 390A.

In some implementations, the CU-to-DU message 306 and the DU-to-CU message 308 can be a UE Context Modification Request message and a UE Context Modification Response message, respectively. In other implementations, the CU-to-DU message 306 and the DU-to-CU message 308 can be new F1 application protocol (AP) messages or new W1 AP messages, respectively. In some implementations, the CU-to-DU message 310 can be a UE Context Release Command message. In other implementations, the CU-to-DU message 310 can be a DL RRC Message Transfer message. In some implementations, the DU-to-CU message 318 can be a UE Context Release Request message, a UE Inactivity Notification message or a UE Context Release Complete message. In other implementations, the DU-to-CU message 318 can be a new F1 AP message or a W1 AP message.

Referring next to FIG. 3B, a scenario 300B is generally similar to the scenario 300A. Events in this scenario similar to those discussed above are labeled with the same reference numbers and the examples and implementations for FIG. 3A can apply to FIG. 3B. The differences between the scenarios of FIG. 3A and FIG. 3B are discussed below.

After receiving 308 the DU-to-CU message, the CU 172 generates an RRC reconfiguration message (e.g., RRCReconfiguration message or RRCConnectionReconfiguraton message), to include the configuration(s) of the second UL and DL BWPs and optionally include at least one configured resources configuration and instruct the UE 102 to transition to the inactive state, instead of the RRC release message. Then the CU 172 send 309 a CU-to-DU message including the RRC reconfiguration message to the DU 174, which in turn transmits 311 a DL MAC PDU including the RRC reconfiguration message to the UE 102 on the first DL BWP. In response to the RRC reconfiguration message, the UE 102 transmits 313 a UL MAC PDU, including a RRC reconfiguration complete message, on the first UL BWP to the DU 174. In turn, the DU 174 sends a CU-to-DU message including the RRC reconfiguration complete message to the CU 172. After transmitting 309 the RRC reconfiguration message or receiving 315 the RRC reconfiguration complete message, the CU 172 sends 317, 319 a RRC release message to the UE via the DU 174, similar to events 310 and 312.

The events 302, 304, 306, 308, 309, 311, 313, 315, 317, 319, 314, 316, and 318 are collectively referred to in FIG. 3A as a BWP configuration procedure 390.

In the RRC reconfiguration message, the CU 172 or DU 174 can indicate the UE 102 that the configuration(s) of the second UL and DL BWPs and/or the at least one configured resources configuration are applied while the UE operates in the inactive state, in some implementations. Thus, the UE 102 retain the configuration(s) of the second UL and DL BWPs and/or the at least one configured resources configuration in response to or after receiving the RRC release message.

In some implementations, the CU-to-DU message 309 can be a DL RRC Message Transfer message. In some implementations, the DU-to-CU message 315 can be a UL RRC Message Transfer message. the CU-to-DU message 317 can be a UE Context Release Command or a DL RRC Message Transfer message.

Referring next to FIG. 3C, a scenario 300C is generally similar to the scenario 300A. Events in this scenario similar to those discussed above are labeled with the same reference numbers, and the examples and implementations for FIG. 3A can apply to FIG. 3C. The differences between the scenarios of FIG. 3A and FIG. 3C are discussed below.

Initially, the UE 102 operates 320 in the inactive state and camps 326 on a first DL BWP of cell 124. Later in time, the UE 102 performs 382 a random access procedure (i.e., 4-step random access procedure) on a first UL BWP and the first DL BWP to perform the MO EDT, MT EDT, transition to the connected state or perform an RAN notification area (RNA) update. The first UL BWP can be the second UL and DL BWPs or the initial UL and DL BWPs as described for FIG. 3A. To initiate 382 the random access procedure, the UE 102 transmits 328 a random access preamble on the first UL BWP to the DU 174. In response, the DU 174 sends 330 a random access response, including a UL grant, on the first DL BWP to the UE 102. Then the UE 102 transmits 332 to the DU 174 an initial UL MAC PDU including a UL RRC message) on radio resources, configured by the UL grant, on the first UL BWP. In turn, the DU 174 sends 334 a DU-to-CU message including the UL RRC message to the CU 172. After transmitting the UL RRC message to the CU 172 via the DU 174, the UE 102 can communicate 336 data with the DU 174 and communicate data with the CU 172 via the DU 174. The UE 102 can operate in the inactive state or in the connected state to communicate 336 data with the DU 174 and the CU 172. In some implementations the UE 102 can communicate 336 the data with the DU 174 on the first UL and DL BWPs. In other implementations, the CU 172 can communicate 336 some of the data with the DU 174 on the first UL and DL BWPs and some of the data with the DU 174 on additional UL and DL BWPs.

The data communicated between the UE 102 and the CU 172 via the DU 174 includes PDCP PDUs, SDAP PDUs, RRC PDUs (including RRC messages) and/or NAS PDUs (including NAS messages). The UL RRC message can be an RRC request message. In response to the UL RRC message, the CU 172 in some implementations can send an RRC response message to the UE 102 via the DU 174 at event 336 to transition the UE 102 to the connected state. In response to the RRC response message, the UE 102 can transition to the connected state and transmit a RRC complete message to the CU 172 via the DU 174 at event 336. For example, the RRC request message, RRC response message and RRC complete message can be an RRC setup request message, an RRC setup message and an RRC setup complete message respectively. In another example, the RRC request message, RRC response message and RRC complete message can be an RRC resume request message, an RRC resume message and an RRC resume complete message respectively. In cases transitioning the UE 102 to the connected state with a RRC setup message, the CU 172 transmits 336 a security mode command message to the UE 102 via the DU 174 to activate security protection (i.e., encryption/decryption and integrity protection/integrity check), and the UE 102 transmits 336 a security mode complete message to the CU 172 via the DU 174 in response. After activating the security protection, the CU 172 transmits 336 to the UE 102 via the DU 174 a RRC reconfiguration message to configure a DRB, and the UE 102 transmits 336 a RRC reconfiguration complete message to the CU 172 via the DU 174 in response. Then, the UE 102 can communicate 336 data on the DRB with the CU 172 via the DU 174.

In other implementations, the CU 172 refrains from sending an RRC response message to the UE 102 via the DU 174 at event 336 to transition the UE 102 the connected state.

After receiving 334 the UL RRC message and/or communicating 336 the data with the UE 102 via the DU 174, the CU 172 can perform 380 the RRC release procedure with the UE 102 on the first UL and/or DL BWPs as described for FIG. 3A.

Referring next to FIG. 3D, a scenario 300D is generally similar to the scenarios 300A and 300C. Events in this scenario similar to those discussed above are labeled with the same reference numbers, and the examples and implementations for FIGS. 3A and 3C can apply to FIG. 3D. The differences among the scenarios of FIGS. 3A, 3C and 3D are discussed below.

Instead of performing 382 the random access procedure of FIG. 3C, the UE 102 here performs 383 a random access procedure with the DU 174 on the first UL and DL BWPs to perform the MO EDT, MT EDT, transition to the connected state or perform an RAN notification area (RNA) update. To initiate 383 the random access procedure (in this case, the 2-step random access procedure), the UE 102 transmits 328 a random access preamble and 331 the initial UL MAC PDU on the first UL BWP to the DU 174. More specifically, the UE 102 transmits 331 the initial UL MAC PDU on radio resources configured in a system information block (SIB). The DU 174 broadcasts the SIB periodically and the UE 102 receives the SIB before initiating 383 the random access procedure. The SIB may include a radio resource configuration configuring the radio resources.

Now referring to FIG. 4A, a scenario 400A is generally similar to the scenarios 300A-300D. Events in this scenario similar to those discussed above are labeled with the similar reference numbers and the examples and implementations for FIGS. 3A-3D can apply to FIG. 4A (e.g., events 390, 391, 392, 393 are similar to event 490; event 320 is similar to event 420; event 324 is similar to event 424; event 328 is similar to event 428; event 382 is similar to event 482; event 383 is similar to event 483). The differences between the scenarios of FIGS. 3A-3D and FIG. 4A are discussed below.

Initially, the UE 102, the DU 174 and the CU 172 perform 490 a BWP configuration procedure, similar to events 390, 391, 392 or 393. The UE operates 420 in the inactive state as a result of the BWP configuration procedure. The CU 172 or DU 174 configures a CG configuration to the UE 102 in the BWP configuration procedure and may or may not configure a SPS configuration to the UE 102 in the BWP configuration procedure. The UE 102 operating in the inactive state can perform 424 early data communication with the DU 174 on first UL and DL BWPs configured in the BWP configuration procedure. More specifically, the UE 102 can transmit 424 UL data to the DU 174 on CG radio resources, on the first UL BWP. In cases that the UE 102 receives a SPS configuration in the BWP configuration procedure, the UE 102 can receive 424 DL data on the first DL BWP SPS radio resources. In such cases, the UE 102 can receive 424 DL data on dynamic radio resources which the DU 174 transmits DCI(s) to allocate.

After transitioning to the inactive state or during 424 the early data communication, the UE 102 determines 425 to initiate a radon access (RA) procedure. Because neither the CU 172 nor the DU 174 configures the UE 102 random access configuration(s) the first UL BWP and/or the first DL BWP, the UE 102 operating in the inactive state camps 422 on a second DL BWP and performs 482 a random access procedure on a second UL BWP and the second DL BWP, in response to the determination 425. The UE 102 switches to the second DL BWP from the first DL BWP to camp 422 on the second DL BWP or adjusts a receiver of the UE 102 to receive on the second DL BWP. For example, the DU 174 does not include random access configuration(s) in a configuration of the first UL BWP and/or a configuration of the first DL BWP and the UE 102 cannot receive random access configuration(s) from the DU 174 via SIB broadcast by the DU 174 on the first DL BWP. In some implementations, the second UL BWP and the second DL BWP can be an initial UL BWP and an initial DL BWP respectively. The UE 102 may or may not include a UL RRC message in the UL MAC PDU at event 432.

In some implementations, the UE 102 in the inactive state makes 425 the determination during event 424 because the UE 102 in the inactive state triggers a scheduling request to request the DU 174 to transmit UL grant(s) to the UE 102 during event 424. In such cases, the UE 102 may not include a UL RRC message in the UL MAC PDU 432. In other implementations, the UE 102 in the inactive state makes 425 the determination because the UE 102 in the inactive state determines to request the CU 172 or DU 174 to broadcast a SIB.

In other implementations, the UE 102 in the inactive state makes 425 the determination because the UE 102 in the inactive state receives from the DU 174 a paging message including a UE NAS paging identity (e.g., NG-5G-S-TMSI or a S-TMSI). In such cases, the UE 102 can include an UL RRC message in the UL MAC PDU 432. In yet other implementations, the UE 102 in the inactive state makes 425 the determination because the UE 102 detects or determines that a failure occurs in the early data communication that the UE 102 performs at event 424. In such cases, the UE 102 can include an UL RRC message in the UL MAC PDU 432. In some implementations, the UE 102 may detect or determine the failure occurs if a timer expires or a counter has reached a maximum value. In other implementations, the failure can be a security check failure (e.g., integrity check failure). In yet other implementations, the UE may detect or determine the failure occurs if signal strength or quality is below threshold(s). In some implementations, the CU 172 or DU 174 can configure the threshold(s) in the RRC release message or the RRC reconfiguration message. In other implementations, the threshold(s) can be predetermined value(s) specified in 3GPP specification(s). In some implementations, the UL RRC message can be the RRC request message described above.

In some implementations, the UE 102 can perform a 2-step random access procedure with the DU 174, similar to the random access procedure 383, instead of the random access procedure 482.

Referring next to FIG. 4B, a scenario 400B is generally similar to the scenario 300A-300D and 400A. Events in this scenario similar to those discussed above are labeled with the similar reference numbers and the examples and implementations for FIGS. 3A-3D can apply to FIG. 4B (e.g., events 390, 391, 392, 393 are similar to event 490; event 320 is similar to event 420; event 324 is similar to event 424; event 328 is similar to event 428; event 382 is similar to event 482; event 383 is similar to event 483). The differences among the scenarios of FIGS. 3A-3D and 4A and FIG. 4B are discussed below.

After transitioning to the inactive state or during 424 the early data communication, the UE 102 determines 425 to initiate a random access (RA) procedure. Because the DU 174 configures the UE 102 with random access configuration(s) for the first UL BWP and/or the first DL BWP, the UE 102 operating in the inactive state camps 423 on the first DL BWP and performs 482 a random access procedure on the first UL BWP and the first DL BWP, in response to the determination 425. In some implementations, the DU 174 can include the random access configuration(s) in the configuration(s) of the first UL BWP and/or the first DL BWP. For example, the DU 174 can include random access channel (RACH) RACH configuration(s) and/or physical RACH configuration(s) in the configuration of the first UL BWP. In another example, the DU 174 can include a search space configuration for receiving a DCI scheduling the random access response 430 in the configuration of the first DL BWP.

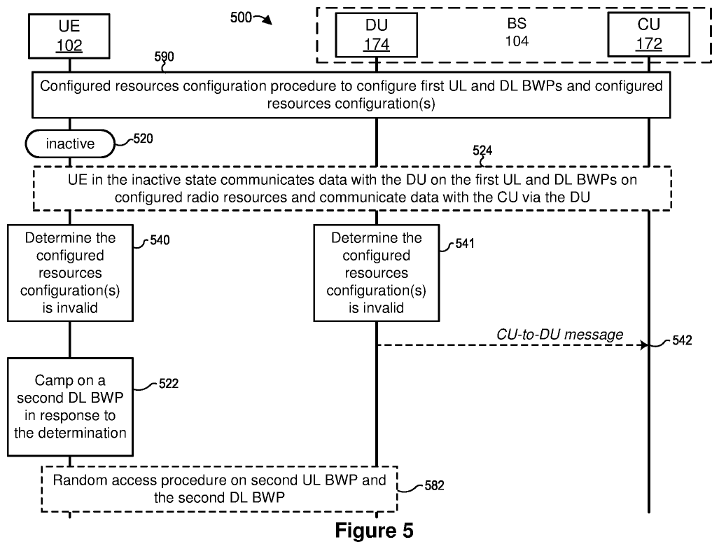

Now, referring to FIG. 5, a scenario 500 is generally similar to the scenarios 300A-300D and 400A-400B. Events in this scenario similar to those discussed above are labeled with the similar reference numbers and the examples and implementations for FIGS. 3A-3D can apply to FIG. 5 (e.g., events 390, 391, 392, 393, 490 are similar to event 590; events 320, 420 are similar to event 520; event 422 is similar to event 522, events 324, 424 are similar to event 524; events 382, 383, 482 are similar to event 582). The differences among the scenarios of FIGS. 3A-3 and 4A-4B and FIG. 5 are discussed below.

After transitioning to the inactive state or during 524 the early data communication, the UE 102 determines 540 the configured resources configuration(s) is invalid. Similarly, the DU 174 determines 541 the configured resources configuration(s) is invalid. In some implementations, the UE 102 starts a first timer for validity of the configuration resources configuration(s). If the first timer expires, the UE 102 determines the configured resource configuration(s) is invalid. Similarly, the DU 174 can start a second timer (e.g., similar to the first timer started by the UE) for validity of the configuration resources configuration(s). If the second timer expires, the DU 174 determines the configured resource configuration(s) is invalid.

In other implementations, the UE 102 starts a first counter for validity of the configuration resources configuration. If the counter reaches a first maximum value, the UE 102 determines the configured resource configuration(s) is invalid. Similarly, the DU 174 can start a second counter (e.g., similar to the first counter started by the UE 102) for validity of the configuration resources configuration. If the second counter reaches a second maximum value, the DU 174 determines the configured resource configuration(s) is invalid. In some implementations, the first maximum value and the second maximum value can be the same. In other implementations, the first maximum value and the second maximum value can be different.

In response to the determination 540, the UE 102 camps 522 on a second DL BWP and can release the configured resources configuration(s). After camping on 522 the second DL BWP, the UE 102 can perform 582 a random access procedure a second UL BWP and the second DL BWP with the DU 174.

In response to the determination 541, the DU 174 can release the configured resources configuration(s). In response to the determination 541, the DU 174 in some implementations can send 542 a DU-to-CU message (e.g., UE Context Release Request message) to the CU 172, e.g., to request the CU 172 to release a UE Context of the UE 102. In response to the DU-to-CU message 542, the CU 172 can send a UE Context Release Command message to the DU 174 to release the UE Context. In response to the UE Context Release Command message, the DU 174 releases the UE Context and can send a UE Context Release Complete message the CU 172. In other implementations, the DU 174 can send 542 a DU-to-CU message (e.g., UE Context Release Request message, a UE Context Modification Required message or a new F1 AP or W1 AP message) to the CU 172, e.g., to indicate the configured resources configuration(s) is invalid or released.

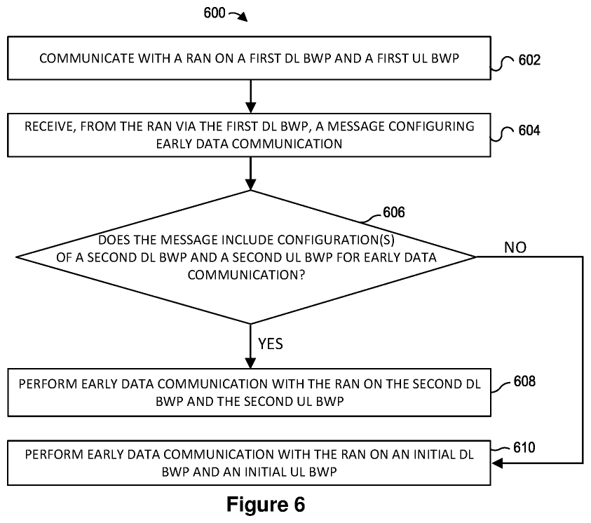

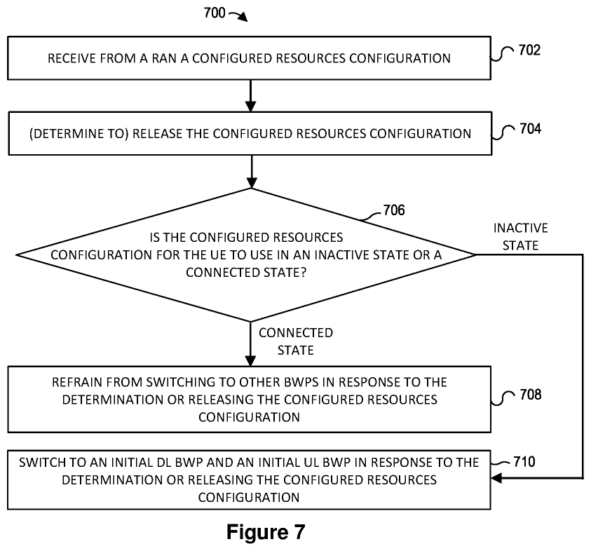

FIGS. 6-13 are flow diagrams depicting methods that a UE (e.g., the UE 102), nodes (e.g., CU 172, DU 174, base station 104) of a RAN (e.g., the RAN 105) or the RAN can perform for managing early data communication on BWPs between the UE and the RAN.

FIG. 6 is a flow diagram of an example method that can be implemented in a UE (e.g., the UE 102) for handling early data communication with a RAN (e.g., the RAN 105) while a radio connection between the UE and the RAN is not active.

At block 602, the UE communicates with a RAN on a first DL BWP and a first UL BWP (e.g., events 304, 382, 383, 336). At block 604, the UE receives, from the RAN via the first DL BWP, a message configuring early data communication (e.g., events 312, 311, 319, 490, 590). At block 606, the UE determines whether the message include configuration(s) of a second DL BWP and a second UL BWP for early data communication (e.g., events 312, 311, 319, 490, 590). If the message includes configuration(s) of the second DL BWP and the second UL BWP for early data communication, the UE at block 608 performs early data communication with the RAN on the second DL BWP and the second UL BWP (e.g., events 324, 424, 524). If the message does not include configuration(s) of a second DL BWP and a second UL BWP for early data communication, the UE at block 610 performs early data communication with the RAN on an initial DL BWP and an initial UL BWP.

In some implementations, the message can include at least one configured resources configuration for early data communication, which can include at least one configured grant (CG) configuration and/or at least one semi-persistent scheduling (SPS) configuration. In cases of the CG configuration(s), the UE in the inactive state can transmit data on a UL BWP (i.e., the second UL BWP or the initial UL BWP) to the RAN using one or more configured grants configured in the CG configuration(s). In cases of the SPS configuration(s), the UE in the inactive state can receive data on a DL BWP (i.e., the second DL BWP or the initial DL BWP) from the RAN using one or more SPS DL assignments configured in the SPS configuration(s). If the message does not include a CG configuration, the UE performs a random access procedure on the UL BWP to initiate early data communication. In cases that the early data communication is a MO EDT, the UE can include data to the RAN on the second UL BWP in a Message 3 or Message A of the random access procedure. Then, the UE in the inactive state can receive, from the RAN on the DL BWP, one or more DCIs for subsequent UL data transmission and transmits data on the UL BWP to the RAN using the DCI(s). If the message does not include a SPS configuration, the UE in the inactive state can receive, from the RAN on the DL BWP, one or more DCIs for DL data transmission and receives data on the DL BWP from the RAN in accordance with the DCI(s).

FIG. 7 is a flow diagram of an example method that can be implemented in a UE (e.g., the UE 102) for handling early data communication with a RAN (e.g., the RAN 105) while a radio connection between the UE and the RAN is not active.

At block 702, the UE receives from a RAN a configured resources configuration (e.g., events 312, 311, 490, 590). At block 704, the UE (determine to) release the configured resources configuration (e.g., event 540). At block 706, the UE determines whether the configured resources configuration is for the UE to use in an inactive state or a connected state (e.g., events 312, 311, 319, 490, 590). If the configured resources configuration is for the UE to use in the connected state, the UE at bloc 708 refrains from switching to other BWPs in response to the determination or releasing the configured resources configuration at block 704. If the configured resources configuration is for the UE to use in the inactive state, the UE at block 710 switches to an initial DL BWP and an initial UL BWP in response to the determination or releasing the configured resources configuration at block 704 (e.g., event 522).

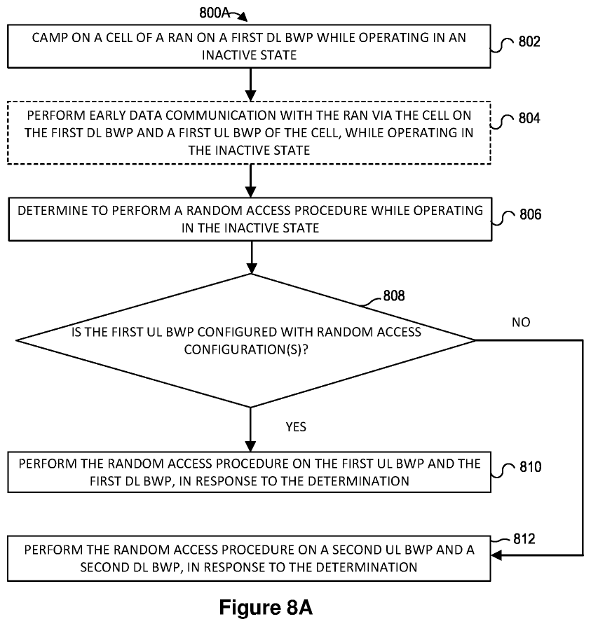

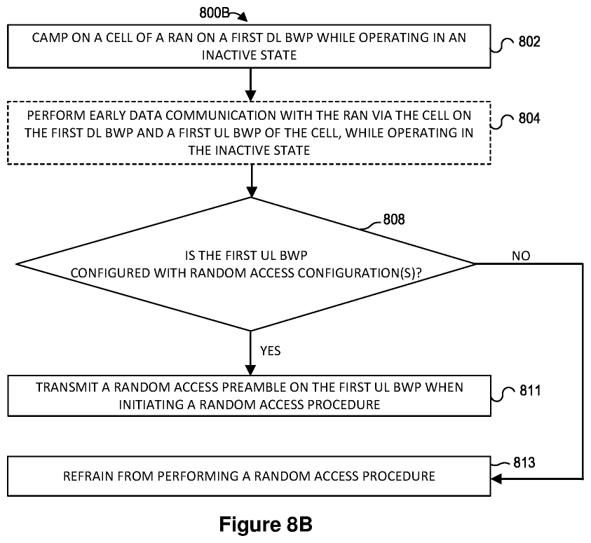

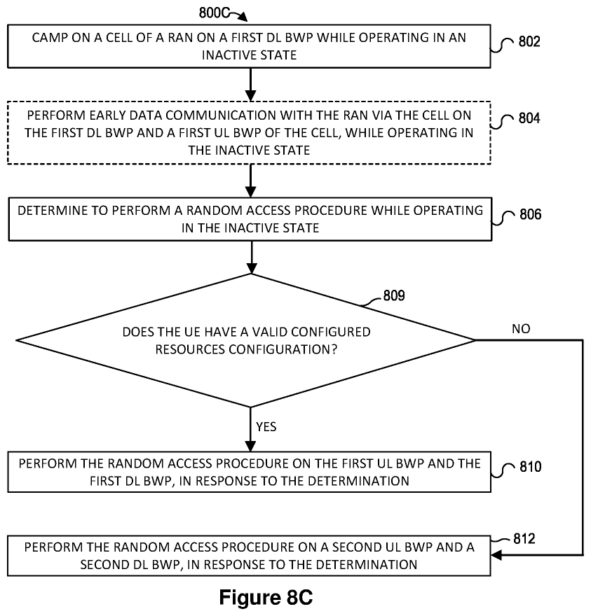

FIG. 8A is a flow diagram of an example method that can be implemented in a UE (e.g., the UE 102) for handling early data communication with a RAN (e.g., the RAN 105) while a radio connection between the UE and the RAN is not active.

At block 802, the UE camps on a cell of a RAN on a first DL BWP while operating in an inactive state (e.g., events 490, 590). At block 804, the UE can perform early data communication with the RAN via the cell on the first DL BWP and a first UL BWP of the cell, while operating in the inactive state (e.g., events 424, 524). Block 804 can be optional. The first UL BWP is associated or paired with the first DL BWP. At block 806, the UE determines to perform a random access procedure while operating in the inactive state (event 425). At block 808, the UE determines whether the first UL BWP is configured with random access configuration(s). If the first UL BWP is configured with random access configuration(s), the UE at block 810 performs the random access procedure on the first UL BWP and the first DL BWP in response to the determination (events 423, 482). If the first UL BWP is not configured with random access configuration(s), the UE at block 812 performs the random access procedure on a second UL BWP and a second DL BWP in response to the determination (e.g., events 422, 482). The second UL BWP is associated or paired with the second DL BWP.

In some implementations, the UE receives from the RAN a RRC release message which configures the UE to transition to the inactive state and configures the first DL BWP and the first UL BWP. If the UE receives the RRC release message in the connected state, the UE transitions to the inactive state. If the UE receives the RRC release message in the inactive state, the UE remains in the inactive state. The UE in the inactive state camps on the first DL BWP in accordance with the configuration of the first DL BWP. In some implementations, the second UL BWP is an initial UL BWP. In some implementations, the UE in the inactive state communicates data with the RAN on configured radio resources on the first UL and DL BWPs. The RRC release message can include CG configuration(s) to configure the configured radio resources.

FIG. 8B is a flow diagram of an example method that can be implemented in a UE (e.g., the UE 102) for handling early data communication with a RAN (e.g., the RAN 105) while a radio connection between the UE and the RAN is not active. Blocks in this method similar those discussed in FIG. 8A are labeled with the same reference numbers and the examples and implementations for FIG. 8A can apply to FIG. 8B. The differences between FIGS. 8A and 8B are discussed below.

If the first UL BWP is configured with random access configuration(s), the UE at block 811 performs a random access procedure on the first UL BWP and the first DL BWP when initiating the random access procedure (events 423, 482). If the first UL BWP is not configured with random access configuration(s), the UE refrains from performing a random access procedure.

In some implementations, the UE at block 813 alternatively refrains from switching to a second UL BWP and/or a second DL BWP to refrain from performing a random access preamble even though the UE 102 determines or identifies random access configuration(s) associated to the second UL BWP and/or the second DL BWP.

FIG. 8C is a flow diagram of an example method that can be implemented in a UE (e.g., the UE 102) for handling early data communication with a RAN (e.g., the RAN 105) while a radio connection between the UE and the RAN is not active. Blocks in this method similar those discussed in FIG. 8A are labeled with the same reference numbers and the examples and implementations for FIG. 8A can apply to FIG. 8C. The differences between FIGS. 8A and 8C are discussed below.

At block 809, the UE determines whether the UE has a valid configured resources configuration. If the UE has a valid configured resources configuration, the UE at block 810 performs the random access procedure on the first UL BWP and the first DL BWP in response to the determination (events 423, 482). If the UE does not have a valid configured resources configuration, the UE at block 812 performs the random access procedure on a second UL BWP and a second DL BWP in response to the determination (e.g., events 422, 482). The second UL BWP is associated or paired with the second DL BWP.

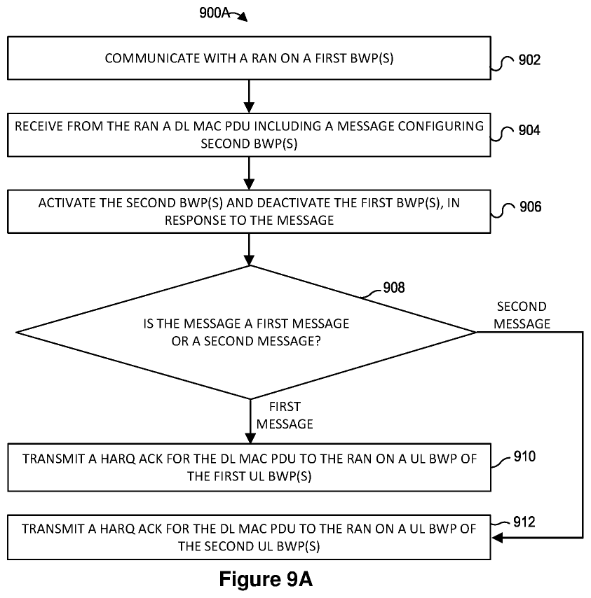

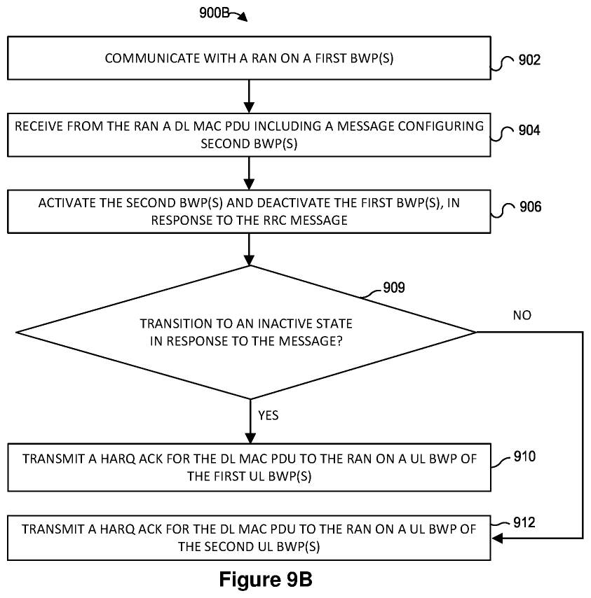

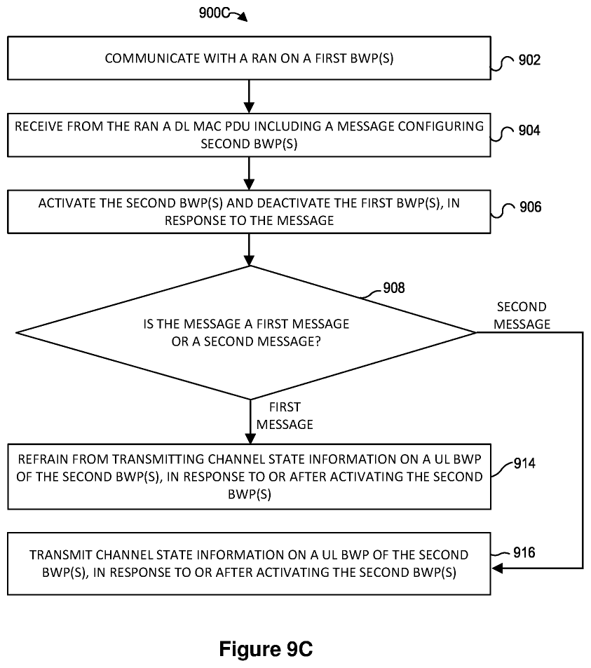

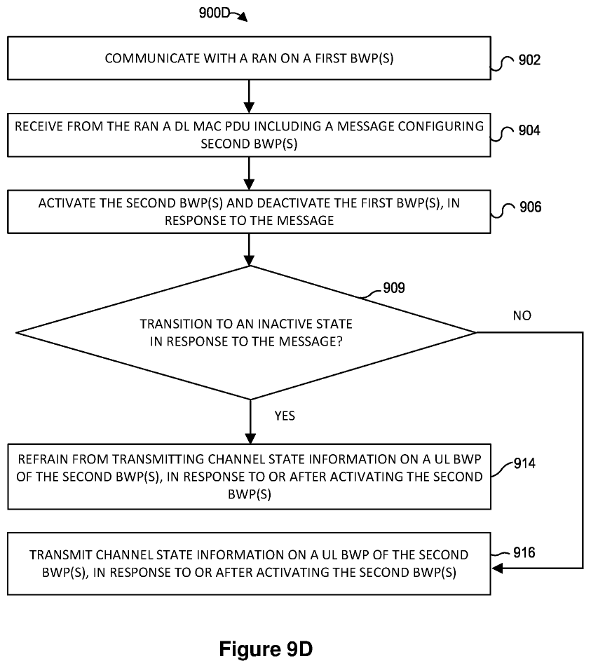

FIG. 9A is a flow diagram of an example method that can be implemented in a UE (e.g., the UE 102) for handling data communication with a RAN (e.g., the RAN 105)

At block 902, the UE communicates with a RAN on a first BWP(s) (e.g., events 304, 382, 383, 336). At block 904, the UE receives from the RAN a DL MAC PDU including a message configuring second BWP(s) (e.g., events 312, 311). At block 906, the UE activates the second BWP(s) and deactivates the first BWP(s), in response to the message (e.g., events 322, 324). At block 908, the UE determines whether the message is a first message or a second message. If the UE at block 908 determines the message is the first message, the UE at block 910 transmits a HARQ ACK for the DL MAC PDU to the RAN on a UL BWP of the first UL BWP(s) (e.g., event 314). If the UE at block 908 determines the message is the second message, the UE at block 912 transmits a HARQ ACK for the DL MAC PDU to the RAN on a UL BWP of the second UL BWP(s).

In some implementations, the UE at block 910 transmits the HARQ ACK on the UL BWP of the first BWP(s) before activating the second BWP(s) and deactivating the first BWP(s). In other implementations, the UE at block 912 transmits the HARQ ACK on the UL BWP of the second BWP(s) after activating the second BWP(s) and deactivating the first BWP(s).

In some implementations, the first message is a RRC release message, and the second message is a RRC reconfiguration message. In some implementations, the RRC reconfiguration message configures the second BWP(s) for the UE to communicate while the UE operates in a connected state. In some scenarios and implementations, if the UE in a connected state receives the RRC release message, the UE transitions to an inactive state in response to the RRC release message. In some implementations, the UE at block 906 activates the second BWP(s) and deactivates the first BWP(s) after transitioning to the inactive state. In other scenarios and implementations, if the UE in the inactive state receives the RRC release message, the UE remains in the inactive state in response to the RRC release message.

In some implementations, the UE transmits a RLC ACK for positively acknowledging reception of a RLC PDU including the message to the RAN on the UL BWP of the first BWP(s), if the message is the first message. In such implementations, the UE transmits the RLC ACK on the UL BWP of the first BWP(s) before activating the second BWP(s) and deactivating the first BWP(s). In other implementations, the UE transmits a RLC ACK for positively acknowledging reception of a RLC PDU including the message to the RAN on the UL BWP of the second BWP(s), if the message is the second message. In such implementations, the UE transmits the RLC ACK on the UL BWP of the second BWP(s) after activating the second BWP(s) and deactivating the first BWP(s).

FIG. 9B is a flow diagram of an example method that can be implemented in a UE (e.g., the UE 102) for handling data communication with a RAN (e.g., the RAN 105). Blocks in this method similar those discussed in FIG. 9A are labeled with the same reference numbers and the examples and implementations for FIG. 9A can apply to FIG. 9B. The differences between FIGS. 9A and 9B are discussed below.

At block 909, the UE determines whether the UE transitions to an inactive state in response to the message. If the UE at block 909 determines the UE transitions to an inactive state in response to the message, the UE at block 910 transmits a HARQ ACK for the DL MAC PDU to the RAN on a UL BWP of the first UL BWP(s) (e.g., event 314). If the UE at block 909 determines the UE does not transition to the inactive state in response to the message (i.e., the UE stays in the connected state), the UE at block 912 transmits a HARQ ACK for the DL MAC PDU to the RAN on a UL BWP of the second UL BWP(s).

In some implementations, the UE transmits a RLC ACK for positively acknowledging reception of a RLC PDU including the message to the RAN on the UL BWP of the first BWP(s), if the UE transitions to the inactive state in response to the message. In such implementations, the UE transmits the RLC ACK on the UL BWP of the first BWP(s) before activating the second BWP(s) and deactivating the first BWP(s). In other implementations, the UE transmits a RLC ACK for positively acknowledging reception of a RLC PDU including the message to the RAN on the UL BWP of the second BWP(s), if the UE does not transition to the inactive state in response to the message. In such implementations, the UE transmits the RLC ACK on the UL BWP of the second BWP(s) after activating the second BWP(s) and deactivating the first BWP(s).

FIG. 9C is a flow diagram of an example method that can be implemented in a UE (e.g., the UE 102) for handling data communication with a RAN (e.g., the RAN 105). Blocks in this method similar those discussed in FIG. 9A are labeled with the same reference numbers and the examples and implementations for FIG. 9A can apply to FIG. 9C. The differences between FIGS. 9A and 9C are discussed below.

At block 908, the UE determines whether the message is a first message or a second message. If the UE at block 908 determines the message is the first message, the UE at block 914 refrains from transmitting channel state information on a UL BWP of the second BWP(s), in response to or after activating the second BWP(s). If the UE at block 908 determines the message is the second message, the UE transmits channel state information on a UL BWP of the second BWP(s), in response to or after activating the second BWP(s).

FIG. 9D is a flow diagram of an example method that can be implemented in a UE (e.g., the UE 102) for handling data communication with a RAN (e.g., the RAN 105). Blocks in this method similar those discussed in FIGS. 9A-9C are labeled with the same reference numbers and the examples and implementations for FIGS. 9A-9C can apply to FIG. 9D. The differences among FIGS. 9A-9C and 9D are discussed below.

At block 909, the UE determines whether the UE transitions to an inactive state in response to the message. If the UE at block 909 determines the UE transitions to an inactive state in response to the message, the UE at block 914 refrains from transmitting channel state information on a UL BWP of the second BWP(s), in response to or after activating the second BWP(s). If the UE at block 909 determines the UE does not transition to the inactive state in response to the message (i.e., the UE stays in the connected state), the UE transmits channel state information on a UL BWP of the second BWP(s), in response to or after activating the second BWP(s).

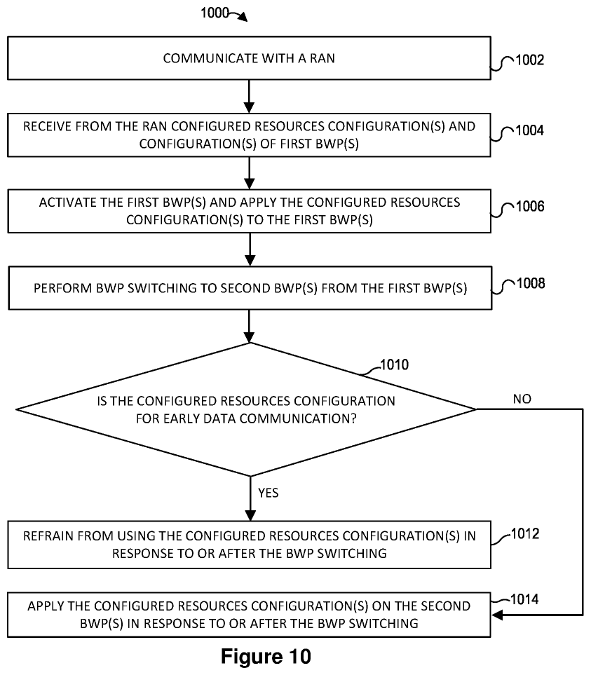

FIG. 10 is a flow diagram of an example method that can be implemented in a UE (e.g., the UE 102) for handling data communication with a RAN (e.g., the RAN 105).

At block 1002, the UE communicates with a RAN (e.g., events 304, 382, 383, 336, 490, 590). At block 1004, the UE receives from the RAN configured resources configuration(s) and configuration(s) of first BWP(s) (e.g., events 312, 313, 490, 590). At block 1006, the UE activates the first BWP(s) and applies the configured resources configuration(s) to the first BWP(s) (e.g., event 322). For example, if the configured resources configuration(s) includes a CG configuration, the UE applies the CG configuration to a first UL BPW of the first BWP(s), i.e., the UE transmits UL MAC PDU(s) on radio resources, configured by the CG configuration, on the first UL BWP. In another example, if the configured resources configuration(s) includes a SPS configuration, the UE applies the SPS configuration to a first DL BWP of the first BWP(s), i.e., the UE receives DL MAC PDU(s) on radio resources, configured by the SPS configuration, on the first DL BWP.

At block 1008, the UE performs BWP switching to second BWP(s) from the first BWP(s) (e.g., events 422, 522). At block 1010, the UE determines whether the configured resources configuration(s) for early data communication. If the UE at block 1010 determines the configured resources configuration(s) is for early data communication, the UE at block 1012 refrains from using the configured resources configuration in response to or after the BWP switching. If the UE at block 1010 determines the configured resources configuration(s) is not for early data communication, the UE applies the configured resources configuration(s) on the second BWP(s) in response to or after the BWP switching.

In some implementations, the UE receives from the RAN at least one RRC message including the configured resources configuration(s) and the configuration(s) of the first BWP(s). In some implementations, the UE performs data communication with the RAN on radio resources, configured by the configured resources configuration(s), on the first BWP(s) after activating the first BWP(s) and applying the configured resources configuration(s) on the first BWP(s).

In some implementations, the UE activates the second BWP(s) and deactivate the first BWP(s) to switch to the second BWP(s) from the first BWP(s). In some implementations, the UE performs data communication with the RAN on radio resources resources, configured by the configured resources configuration(s), on the second BWP(s) after activating the second BWP(s) and applying the configured resources configuration(s) on the second BWP(s).

In some implementations, the UE at block 1012 can deactivate the configured resources configuration(s) to refrain from using the configured resources configuration(s). In some implementations, the UE can retain the configured resources configuration(s). Thus, the RAN can enable the UE to reactivate the configured resources configuration(s) at a later time, e.g., by transmitting a message (e.g., RRC release message or a DCI) to the UE. In other implementations, the UE at block 1012 can release the configured resources configuration(s) to refrain from using the configured configuration(s).

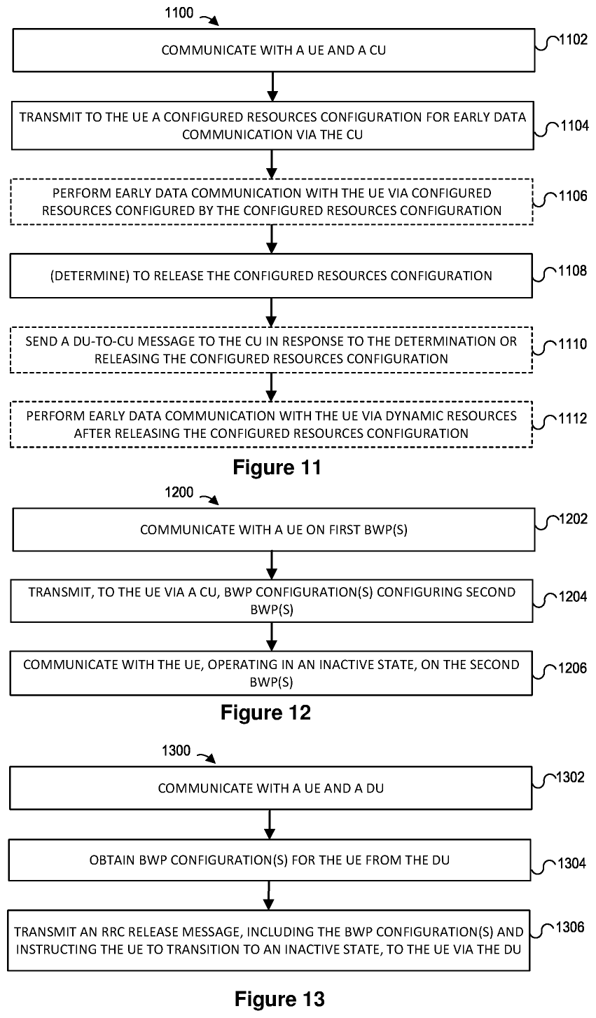

FIG. 11 is a flow diagram of an example method that can be implemented in a DU (e.g., the DU 174 of the base station 104) for handling data communication with a UE (e.g., the UE 102).

At block 1102, the DU communicates with a UE and a CU (e.g., the CU 172 of the base station 104) (e.g., events 304, 382, 383, 336, 490, 590). At block 1104, the DU transmits to the UE a configured resources configuration for early data communication via the CU (e.g., events 312, 313, 490, 590). At block 1106, the DU can perform early data communication with the UE via configured resources configured by the configured resources configuration (e.g., events 324, 424, 524). At block 1108, the DU can (determine) to release the configured resources configuration (e.g., event 541). At block 1110, the DU can send a DU-to-CU message to the CU in response to the determination or releasing the configured resources configuration (e.g., event 542). At block 1112, the DU can perform early data communication with the UE via dynamic resources after releasing the configured resources configuration (e.g., events 482, 582). Blocks 1106, 1110 and 1112 can be optional.

In some implementations, the DU can detect a condition for releasing the configured resources configuration is met and (determine to) release the configured resources configuration in response to the detection. For example, the condition can be expiry of a timer (e.g., validity timer of the configured resources configuration). The DU starts the timer in response to generating or transmitting the configured resources configuration. In another example, the condition can be that a counter has reached a maximum number of consecutive occasions of configured resources where the DU does not detect or receive transmissions from the UE, if the configured resources configuration is a CG configuration. In yet another example, the condition can be that a maximum number of consecutive occasions of configured resources has been reached or passed, since the DU transmits the configured resources configuration to the UE at block 1104.

In some implementations, the DU at block 1110 sends the DU-to-CU message (e.g., UE Context Release Request message) to the CU to indicate that the DU determines or requests to release the configured resources configuration. In other implementations, the DU at block 1110 sends the DU-to-CU message (e.g., UE Inactivity Notification message) to the CU to indicate inactivity of the UE. In response to the DU-to-CU message, the CU can send a CU-to-DU message (e.g., UE Context Release Command or UE Context Modification Request message) to the DU to release the configured resources configuration. The DU can send a second DU-to-CU message (e.g., UE Context Release Complete or UE Context Modification Response message) to the CU in response to the CU-to-DU message.

FIG. 12 is a flow diagram of an example method that can be implemented in a DU (e.g., the DU 174 of the base station 104) for handling data communication with a UE (e.g., the UE 102).

At block 1202, the DU communicates with a UE on first BWP(s) (e.g., events 304, 390, 391, 392, 393). At block 1204, the DU transmits, to the UE via a CU, BWP configuration(s) configuring second BWP(s) (e.g., 308, 310, 312, 309, 311, 490, 590). At block 1206, the DU communicates with the UE, operating in an inactive state, on the second BWP(s) (e.g., events 324, 424, 524).

The first BWP(s) can include a first UL BWP and a first DL BWP and the second BWP(s) can include a second UL BWP and a second DL BWP. In some implementations, the first BWP(s) and the second BWP(s) are the same. In other implementations, the first BWP(s) and the second BWP(s) are different. In some implementations, the DU at block 1204 can transmit configured resources configuration(s) to the UE via the CU and the DU can communicate with the UE on the second BWP(s) in accordance with the configured resources configuration(s). In some implementations, the BWP configuration(s) includes UL BWP configuration(s) (e.g., BWP-Uplink, BWP-UplinkCommon and/or BWP-UplinkDedicated IE(s)) configuring the second UL BWP and/or DL BWP configuration(s) (e.g., BWP-Downlink, BWP-DownlinkCommon and/or BWP-DownlinkDedicated IE(s)) configuring the second DL BWP.

In some implementations, the DU can include a first configured resources configuration and/or random access configuration(s) in the UL BWP configuration. In other implementations, the DU can include a second configured resources configuration and/or in the DL BWP configuration. Alternatively, the DU may not configure a configured resources configuration for uplink transmission or downlink reception for the UE operating in the inactive state.

FIG. 13 is a flow diagram of an example method that can be implemented in a CU (e.g., the CU 172 of the base station 104) for handling data communication with a UE (e.g., the UE 102).

At block 1302, the CU communicates with a UE and a DU (e.g., events 304, 390, 391, 392, 393). At block 1304, the CU obtains BWP configuration(s) for the UE from the DU (e.g., events 308, 490, 590). At block 1306, the CU transmits a RRC release message, including the BWP configuration(s) and commanding the UE to transition to an inactive state, to the UE via the DU (e.g., events 310, 312, 490, 590).

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”.

If a cell is operated in a Time Division Duplex (TDD) mode or on a TDD carrier frequency, a DL BWP and a UL BWP (i.e., associated with the DL BWP) of the cell can be the same BWP. If a cell is operated in a Frequency Division Duplex (FDD) mode or on a pair of FDD carrier frequencies (i.e., UL carrier frequency and DL carrier frequency), a DL BWP and a UL BWP (i.e., associated with the DL BWP) of cell are different BWPs. In this case, the DL BWP is a BWP of the DL carrier frequency and the UL BWP is a BWP of the UL carrier frequency. In some implementations, one of the UL BWPs of a cell can partially overlap the other or has no overlap with the other. In other implementations, one of the UL BWPs can be entirely within the other. In some implementations, one of the DL BWPs of a cell can partially overlap the other or has no overlap with the other. In other implementations, one of the DL BWPs can be entirely within the other.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.

Example 1. A method in a UE for receiving or originating SDT comprises communicating, by processing hardware, with a radio access network (RAN) on a first downlink (DL) bandwidth part (BWP), in a connected state of a protocol for controlling radio resources; receiving, by the processing hardware from the RAN, a configuration for a second DL BWP; camping on the second DL BWP when the UE operates in a non-connected state of the protocol; and performing MT SDT on the second DL BWP or MO SDT a UL BWP corresponding to the second DL BWP.

Example 2. The method of example 1, where receiving the configuration includes receiving a command to release an active radio connection with the RAN, the command associated with the protocol for controlling radio resources.

Example 3. The method of example 1, where receiving the configuration includes receiving a command to reconfigure an active radio connection with the RAN, the command associated with the protocol for controlling radio resources.

Example 4. A method for managing SDT in a UE, implemented in a CU of a distributed base station that also includes a DU, comprises communicating, by processing hardware and via a DU, with a UE operating in a connected state of a protocol for controlling radio resources and configured to communicate with the DU via a first BWP; configuring, by processing hardware and via the DU, the UE to communicate with the DU on a second BWP in a non-connected state of the protocol; and performing, by the processing hardware via the DU, SDT with the UE operating in the non-connected state of the protocol.

Example 5. The method of example 4, wherein performing the SDT includes performing mobile-originated (MO) SDT in an uplink direction.

Example 6. The method of example 4, wherein performing the SDT includes performing mobile-originated (MT) SDT in a downlink direction.

Example 7. The method of any of examples 4-6, wherein the non-connected state of the protocol is RRC_INACTIVE.

Example 8. The method of any of examples 4-6, wherein the non-connected state of the protocol is RRC_IDLE.

Example 9. A method for managing SDT in a UE, implemented in a DU of a distributed base station that also includes a CU, comprises: communicating, by processing hardware, with a UE on a first BWP, when the UE operates in a connected state of a protocol for controlling radio resources; receiving, from the CU, a configuration according to which the UE is to perform SDT in a non-connected state of the protocol, the configuration including an indication of a second BWP; and performing SDT with the UE on the second BWP when the UE operates in the non-connected state of the protocol.

Example 10. The method of example 9, wherein transmitting configuration for the second BWP includes transmitting a DL MAC PDU.

Example 11. The method of example 10, wherein the DL MAC PDU includes a DL RLC PDU.

Example 12. The method of example 11, wherein the DL RLC PDU includes an RRC message.

What is claimed is:

1. A method for managing small data transmission (SDT) in a UE, the method implemented in a central unit (CU) of a distributed base station that also includes a distributed unit (DU), the method comprising:
communicating, by processing hardware and via the DU, with the UE operating in a connected state of a protocol for controlling radio resources and configured to communicate with the DU via a first bandwidth part (BWP);
configuring, by the processing hardware and via the DU, the UE to communicate with the DU on a second BWP when the UE is in a non-connected state of the protocol; and
performing, by the processing hardware via the DU, SDT with the UE operating in the non-connected state of the protocol.

2. The method of claim 1, wherein configuring the UE includes:
transmitting, in a CU-to-DU message, a command to release an active connection between the UE and the distributed base station, the command including a configuration of the second BWP.

3. The method of claim 1, wherein configuring the UE includes:
transmitting, in a CU-to-DU message, a command to reconfigure an active connection between the UE and the distributed base station, the command including a configuration of the second BWP.

4. The method of claim 2 or 3, further comprising:
receiving the configuration for the second BWP from the DU.

5. The method of any of the preceding claims, further comprising:
receiving, from the DU, a configured grant (CG) configuration;
wherein configuring the UE includes:
transmitting, to the UE via the DU, the CG configuration for use on the second BWP.

6. The method any of the preceding claims, wherein the second BWP at least partially overlaps the first BWP.

7. The method any of the preceding claims, wherein the second BWP includes a downlink (DL) BWP and an uplink (UL) BWP.

8. A method for managing small data communication (SDT) in a UE, the method implemented in a distributed unit (DU) of a distributed base station that also includes a central unit (CU), the method comprising:
communicating, by processing hardware, with the UE on a first bandwidth part (BWP), when the UE operates in a connected state of a protocol for controlling radio resources;
receiving, from the CU, a configuration according to which the UE is to perform SDT in a non-connected state of the protocol, the configuration including an indication of a second BWP;
transmitting, by the processing hardware and on the first BWP, the configuration to the UE; and
performing SDT with the UE on the second BWP when the UE operates in the non-connected state of the protocol.

9. The method of claim 8, wherein:
transmitting the configuration to the UE includes transmitting a downlink (DL) Radio Link Control (RLC) protocol data unit (PDU); the method further comprising:
receiving, by the processing hardware, an RLC acknowledgement on the first BWP.

10. The method of claim 8, further comprising:
receiving, by the processing hardware on first BWP and after transmitting the configuration to the UE, a hybrid automatic repeat request (HARQ) acknowledgement (ACK) related corresponding to a previously transmitted DL HARQ message.

11. The method of claim 9 or 10, further comprising:
transmitting, in the DL RLC PDU, a command to release or reconfigure an active radio connection between the UE and the DU, the command associated with a protocol for controlling radio resources.

12. The method of claim 8, wherein transmitting the configuration includes:
transmitting a command to release an active radio connection between the UE and the DU, when the UE is performing SDT on the first BWP.

13. The method of any of claims 8-12, further comprising:
transmitting, to the UE, a CG configuration;
wherein the SDT on the second BWP conforms to the CG configuration.

14. The method of any of claims 8-12, wherein performing the SDT with the UE on the second BWP includes:
performing a random access procedure on the second BWP.

15. A network node comprising processing hardware and configured to implement a method according to any of the preceding claims.
